(19) United States
(12) Patent Application Publication
(10) Pub. No.: US 2010/0091098 A1
(43) Pub. Date: Apr. 15, 2010

(54) DISPLAY APPARATUS, DISPLAY METHOD, AND DISPLAY SYSTEM

(75) Inventors: Kazunari YOSHIFUJI, Tokyo (JP); Isao Ohashi, Kanagawa (JP); Takuya Ooi, Tokyo (JP); Shuichi Takahashi, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/560,988

(22) Filed: Sep. 16, 2009

(30) Foreign Application Priority Data
Oct. 15, 2008 (JP) 2008-266793

(51) Int. Cl. H04N 13/04

(52) U.S. Cl. 348/54; 348/E13.001

(57) ABSTRACT

A display apparatus includes: a video display unit that converts a video signal containing information indicating the magnitude of disparity between left-eye and right-eye video images into video images and displays the video images on a screen; a projection distance detector that detects a projection distance that is the distance between the video display unit and the screen; a display size calculator that calculates the size of the video images displayed on the screen using the projection distance detected by the projection distance detector; a disparity magnitude detector that detects the information indicating the magnitude of disparity from the video signal; and a disparity magnitude adjuster that adjusts the magnitude of disparity using the size of the video images displayed on the screen and the information indicating the magnitude of disparity detected by the disparity magnitude detector.

### BACKGROUND OF THE INVENTION

1. Field of the Invention

The present invention relates to a display apparatus, a display method, and a display system useable in a front-projection projector that displays three-dimensional stereoscopic video images.

Specifically, information indicating the magnitude of disparity between left-eye and right-eye video images and the video image display size determined from a projection distance are used to adjust the magnitude of disparity, whereby the magnitude of disparity can be optimized and automatically adjusted.

2. Description of the Related Art

In recent years, front-projection projectors have been advancing in terms of resolution and image quality, and quite a few users have such projectors installed in their living rooms and convert them into home theaters. Further, increase in the number of movie theaters with facilities capable of showing stereoscopic video content using left and right disparity video images may lead to increase in the number of home-use projectors capable of presenting stereoscopic video content.

In a method for presenting left and right disparity video images, a display apparatus displays left-eye and right-eye video images with a certain amount of shift (magnitude of disparity) in such a way that the left eye of a viewer receives the left-eye video images and the right eye of the viewer receives the right-eye video images. As a result, the viewer can view the left and right disparity video images. Left and right disparity video images are formed of left-eye and right-eye video images with a certain magnitude of disparity in the horizontal direction. The larger the magnitude of disparity, the more the viewer can experience a pop-out effect or a sense of depth.

FIGS. 14A and 14B are descriptive diagrams showing an example of the relationship between the left/right eyes of a viewer and left/right disparity video images (No. 1). As shown in FIG. 14A, left-eye video images 131 and right-eye video images 141 are displayed on a screen 20 in such a way that the line of sight from the left eye 160 of the viewer intersects the line of sight from the right eye 170 of the viewer. The viewer looks at the left-eye video images 131 with the left eye 160 of the viewer and the right-eye video images 141 with the right eye 170 of the viewer and feels as if stereoscopic video images 151 are displayed in front of the screen 20. That is, the viewer can view video images that produce a pop-out effect.

Alternatively, as shown in FIG. 14B, left-eye video images 132 and right-eye video images 142 are displayed on the screen 20 in such a way that the line of sight from the left eye 160 of the viewer does not intersect the line of sight from the right eye 170 of the viewer. The viewer then feels as if stereoscopic video images 152 are displayed behind the screen 20. That is, the viewer can view video images that produce a sense of depth.

However, the magnitude of disparity of stereoscopic video images that produce a pop-out effect, a sense of depth, or any other stereoscopic effect should be within a certain range. When the magnitude of disparity is too large, the viewer may suffer from eyestrain or may not be able to recognize displayed video images as stereoscopic video images.

FIGS. 15A and 15B are descriptive diagrams showing another example of the relationship between the left/right eyes of the viewer and left/right disparity video images (No. 2). As shown in FIG. 15A, left-eye video images 133 and right-eye video images 143 are displayed on the screen 20 in such a way that the lines of sight from the left eye 160 and the right eye 170 of the viewer are directed outward. The viewer is not able to view the thus displayed video images, because no person can direct their left and right eyes outward at the same time.

On the other hand, as shown in FIG. 15B, when the magnitude of disparity between left-eye video images 134 and right-eye video images 144 displayed on the screen 20 is too large, the video images 134 and 144 do not merge and the viewer may suffer from eyestrain.

JP-A-2005-73013 discloses a stereoscopic image display apparatus. According to the stereoscopic image display apparatus, a user inputs a display size on a screen, the number of pixels, and other information to adjust the magnitude of disparity between left and right disparity images, and the left and right disparity images are magnified or demagnified based on the input information. The magnitude of disparity is thus adjusted.

### SUMMARY OF THE INVENTION

As described above, the stereoscopic image display apparatus described in JP-A-2005-73013 can reduce eyestrain of the viewer by adjusting the magnitude of disparity between the left and right disparity video images based on the input information indicating the magnitude of disparity. When the apparatus is a projector, however, the conditions under which users install the projector differ from one another in many cases and the magnitude of disparity greatly depends on the size of the video images displayed on a screen or any other similar surface. It is therefore difficult to adjust the magnitude of disparity in the stereoscopic image display apparatus described in JP-A-2005-73013.

Thus, it is desirable to provide a display apparatus with a function of automatically adjusting the magnitude of disparity irrespective of the environment where the display apparatus is installed, the function relieving the user of the burden of adjusting the magnitude of disparity but providing an optimized magnitude of disparity.

According to an embodiment of the invention, there is provided a display apparatus including a video display unit that converts a video signal containing information indicating the magnitude of disparity between left-eye and right-eye video images into video images and displays the video images on a screen, a projection distance detector that detects a projection distance that is the distance between the video display unit and the screen, a display size calculator that calculates the size of the video images displayed on the screen using the projection distance detected by the projection distance detector, a disparity magnitude detector that detects the information indicating the magnitude of disparity from the video signal, and a disparity magnitude adjuster that adjusts the magnitude of disparity using the size of the video images displayed on the screen and the information indicating the magnitude of disparity detected by the disparity magnitude detector.

In the display apparatus according to the above embodiment of the invention, the video display unit converts a video signal containing information indicating the magnitude of disparity between left-eye and right-eye video images into video images and displays the video images on a screen. The projection distance detector detects a projection distance that is the distance between the video display unit and the screen. The display size calculator uses the projection distance detected by the projection distance detector to calculate the size of the video images displayed on the screen. The disparity magnitude detector detects the information indicating the magnitude of disparity from the video signal. The disparity magnitude adjuster uses the size of the video images displayed on the screen and the information indicating the magnitude of disparity detected by the disparity magnitude detector to adjust the magnitude of disparity. This configuration can provide an optimized magnitude of disparity.

A display method according to another embodiment of the invention causes a display apparatus displaying left-eye video images and right-eye video images on a screen to carry out the steps of: receiving a video signal containing information indicating the magnitude of disparity between the left-eye video images and the right-eye video images and detecting the information indicating the magnitude of disparity from the video signal, detecting a projection distance that is the distance between the display apparatus and the screen, calculating the size of the video images displayed on the screen using the detected projection distance, adjusting the magnitude of disparity using the calculated size of the video images to be displayed and the detected information indicating the magnitude of disparity, and displaying the video images on the screen by using the adjusted magnitude of disparity.

A display system according to another embodiment of the invention includes a first display apparatus including a first video display unit that converts a video signal containing information indicating the magnitude of disparity between left-eye and right-eye video images into video images and displays the video images on a screen, a first projection distance detector that detects a projection distance that is the distance between the first video display unit and the screen, a first display size calculator that calculates the size of the video images displayed on the screen using the projection distance detected by the first projection distance detector, a first disparity magnitude detector that detects the information indicating the magnitude of disparity from the video signal, and a first disparity magnitude adjuster that adjusts the magnitude of disparity using the size of the video images displayed on the screen and the information indicating the magnitude of disparity detected by the first disparity magnitude detector, and a second display apparatus including a second video display unit that converts the video signal containing the information indicating the magnitude of disparity between the left-eye and right-eye video images into video images and displays the video images on the screen, a second projection distance detector that detects a projection distance that is the distance between the second video display unit and the screen, a second display size calculator that calculates the size of the video images displayed on the screen using the projection distance detected by the second projection distance detector, a second disparity magnitude detector that detects the information indicating the magnitude of disparity from the video signal, and a second disparity magnitude adjuster that adjusts the magnitude of disparity using the size of the video images displayed on the screen and the information indicating the magnitude of disparity detected by the second disparity magnitude detector.

According to the display apparatus, the display method, and the display system according to the above embodiments of the invention, the video image display size and the information indicating the magnitude of disparity are used to adjust the magnitude of disparity. This configuration relieves the user of the burden of adjusting the magnitude of disparity but provides an optimized magnitude of disparity, whereby the magnitude of disparity can be automatically adjusted.

### BRIEF DESCRIPTION OF THE DRAWINGS

FIG. 1 is a descriptive diagram showing an exemplary configuration of a display apparatus 100 according to an embodiment;

FIG. 2 is a block diagram showing an exemplary configuration of the display apparatus 100;

FIG. 3 is a descriptive diagram showing an example of how the magnitude of disparity looks like;

FIG. 4 shows graphs illustrating examples of the relationship between a projection distance and a display size;

FIG. 5 is a descriptive diagram showing an exemplary configuration of a video display unit 103;

FIG. 6 is a flowchart showing an example of the operation of a disparity magnitude adjuster 102;

FIG. 7 is a flowchart showing an example of the operation of the display apparatus 100;

FIG. 8 is a descriptive diagram showing an exemplary configuration of a display system 200 according to a second embodiment;

FIG. 9 is a block diagram showing an exemplary configuration of the display system 200;

FIG. 10 is a flowchart showing an example of the operation of the display system 200;

FIG. 11 is a descriptive diagram showing an exemplary configuration of a display system 300 according to a third embodiment;

FIG. 12 is a block diagram showing an exemplary configuration of the display system 300;

FIG. 13 is a flowchart showing an example of the operation of the display system 300;

FIGS. 14A and 14B are descriptive diagrams showing an example of the relationship between the left/right eyes and left/right disparity video images (No. 1); and

FIGS. 15A and 15B are descriptive diagrams showing another example of the relationship between the left/right eyes and left/right disparity video images (No. 2).

### DESCRIPTION OF THE PREFERRED EMBODIMENTS

The best mode for carrying out the invention (hereinafter referred to as an “embodiment”) will be described. The description will be made in the following order:

1. First embodiment (Exemplary configuration of display apparatus)

2. Second embodiment (When two display apparatus are used, No. 1)

3. Third embodiment (When two display apparatus are used, No. 2)

### First Embodiment

### Exemplary Configuration of Display Apparatus

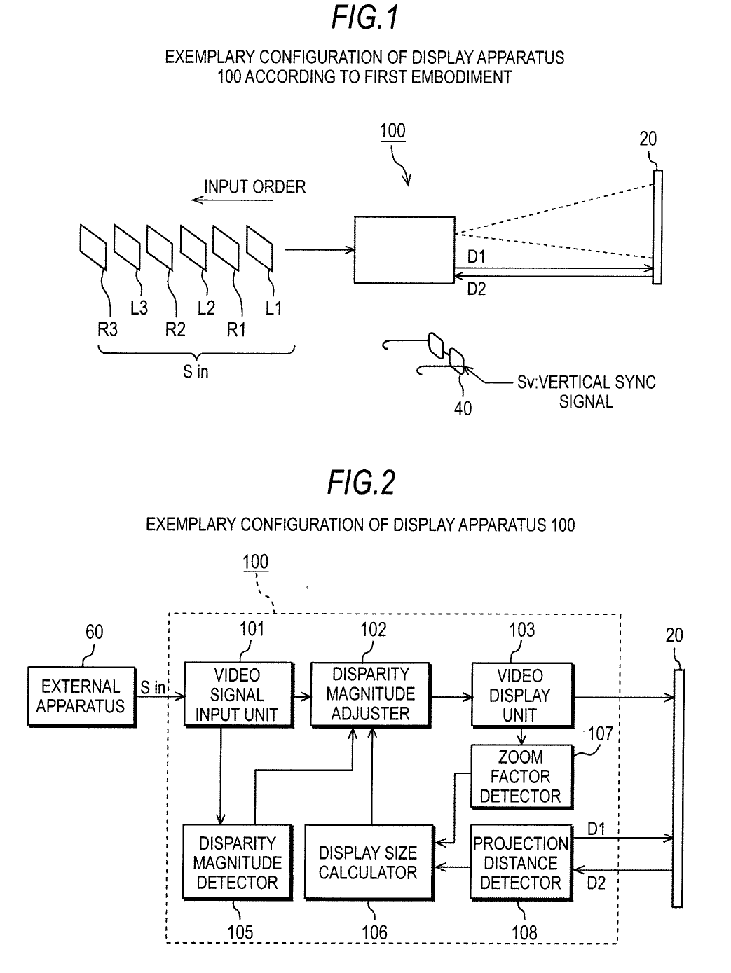

A display apparatus according to an embodiment of the invention will be described below with reference to the drawings. FIG. 1 is a descriptive diagram showing an exemplary configuration of a display apparatus 100 according to a first embodiment. The display apparatus 100 shown in FIG. 1 can be used, for example, in a front-projection projector that displays three-dimensional stereoscopic video images.

As shown in FIG. 1, the display apparatus 100 receives a video signal Sin. The video signal Sin is formed of left-eye image signals L1, L2, and L3, right-eye image signals R1, R2, and R3, and information indicating the magnitude of disparity (not shown). The display apparatus 100 receives the left-eye image signals and the right-eye image signals multiplexed in the following order by using time division multiplexing: the left-eye image signal L1, the right-eye image signal R1, the left-eye image signal L2, the right-eye image signal R2, the left-eye image signal L3, and the right-eye image signal R3. In the order in which the image signals are inputted, the corresponding video images are displayed on a screen 20.

The display apparatus 100 detects the distance between the display apparatus 100 and the screen 20 (hereinafter referred to as a projection distance) by radiating an incident signal D1 to the screen 20 and receiving a reflection signal D2 reflected off the screen 20. The display apparatus 100 uses the detected projection distance and the information indicating the magnitude of disparity contained in the video signal Sin to adjust the magnitude of disparity, and displays left and right disparity video images having the adjusted magnitude of disparity on the screen 20.

A viewer wears liquid crystal shuttering glasses 40 and looks at the video images displayed on the screen 20. The liquid crystal shuttering glasses 40 repeat an operation of alternately turning left-eye and right-eye shutters ON and OFF in such a way that the right-eye shutter is ON when the left-eye shutter is OFF whereas the right-eye shutter is OFF when the left-eye shutter is ON. The ON/OFF operation carried out by the liquid crystal shuttering glasses 40 is synchronized with a vertical sync signal Sv outputted from the display apparatus 100. The configuration described above allows the left-eye of the viewer to receive only the left-eye video images and the right-eye of the viewer to receive only the right-eye video images.

As described above, the viewer, who wears the liquid crystal shuttering glasses 40 and looks at the left and right disparity video images thus displayed on the screen 20, can view three-dimensional stereoscopic video images.

FIG. 2 is a block diagram showing an exemplary configuration of the display apparatus 100. As shown in FIG. 2, the display apparatus 100 includes a disparity magnitude adjuster 102, a video display unit 103, a disparity magnitude detector 105, a display size calculator 106, and a projection distance detector 108. The display apparatus 100 further includes a video signal input unit 101 and a zoom factor detector 107.

The video signal Sin containing the information indicating the magnitude of disparity between the left-eye and right-eye video images is inputted from an external apparatus 60 to the video signal input unit 101. The video signal input unit 101 is connected to the disparity magnitude detector 105. The disparity magnitude detector 105 detects the information indicating the magnitude of disparity contained in the video signal Sin.

The video signal input unit 101 and the disparity magnitude detector 105 are connected to the disparity magnitude adjuster 102. The disparity magnitude adjuster 102 receives the video signal Sin outputted from the video signal input unit 101, receives the information indicating the magnitude of disparity outputted from the disparity magnitude detector 105, and receives the video image display size from the display size calculator 106, which will be described later. The disparity magnitude adjuster 102 uses the information indicating the magnitude of disparity and the video image display size to calculate the magnitude of disparity. Based on the calculated magnitude of disparity, the disparity magnitude adjuster 102 adjusts the amount of disparity between the left and right disparity video images provided from the video signal Sin.

The disparity magnitude adjuster 102 is connected to the video display unit 103. The video display unit 103 receives information on the left and right disparity video images having the adjusted magnitude of disparity, performs a variety of operations on the received information, and converts the information on the left and right disparity video images into video images. The video display unit 103 includes a zoom lens (not shown) and has a function of magnifying video images through the zoom lens and displaying the magnified video images on the screen 20.

The projection distance detector 108 detects the projection distance. For example, the projection distance detector 108 detects the projection distance by radiating the incident signal D1 to the screen 20 and receiving the reflection signal D2 reflected off the screen 20. The incident signal D1 may be formed of an ultrasonic wave, an infrared laser beam, or a red laser beam.

The projection distance detector 108 is connected to the display size calculator 106. The display size calculator 106 uses the information indicating the projection distance and the information indicating the zoom factor detected by the zoom factor detector 107, which will be described later, to calculate the size of the video images displayed on the screen 20.

The video display unit 103 described above is connected to the zoom factor detector 107. The zoom factor detector 107 detects the zoom factor, which is the magnification of the zoom lens. The zoom factor detector 107 has a function of holding the information indicating the zoom factor. For example, when the zoom lens magnifies video images 1.5 times, the zoom factor detector 107 holds information indicating “1.5 times”. The zoom factor detector 107 is connected to the display size calculator 106 and outputs the information indicating the zoom factor to the display size calculator 106.

The configuration described above relieves the user of the burden of adjusting the magnitude of disparity but provides an optimized magnitude of disparity, whereby the magnitude of disparity can be automatically adjusted.

The function of each of the portions of the display apparatus 100 will be described in detail. The video signal input unit 101 has a DVI (Digital Visual Interface), an HDMI (High-Definition Multimedia Interface), or any other suitable interface that allows the video signal input unit 101 to be connected to the external apparatus 60, which is a Blu-ray® player, a DVD player, or any other suitable reproducing apparatus. When the display apparatus 100 is connected to the external apparatus 60 via a DVI or HDMI terminal, the transmitted electric signal is a differential signal.

The differential signal is produced, for example, by TMDS (Transition Minimized Differential Signaling). TMDS serializes a plurality of parallel video signals and thus reduces the number of signal lines. The video signal input unit 101 can deserialize and convert the input video signal having been produced by using TMDS into parallel video signals.

The disparity magnitude detector 105 detects the information indicating the magnitude of disparity between the left and right disparity video images contained in the video signal Sin inputted to the video signal input unit 101. When the external apparatus 60 has identified the information indicating the magnitude of disparity between the left and right disparity video images, the disparity magnitude detector 105 detects the information indicating the magnitude of disparity. The disparity magnitude detector 105 holds the information indicating the magnitude of disparity detected by the external apparatus 60.

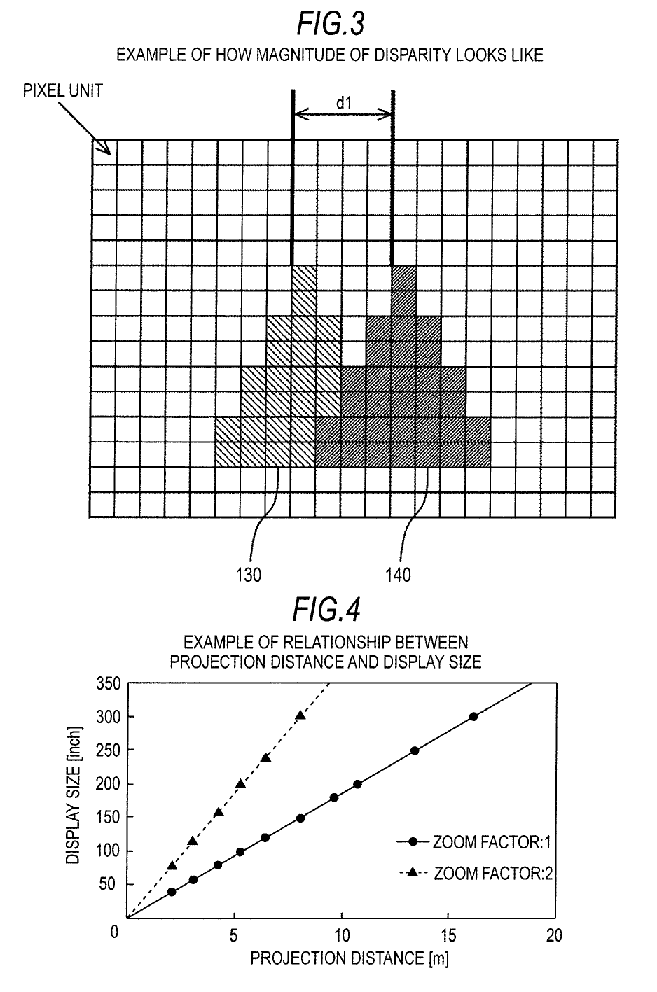

FIG. 3 is a descriptive diagram showing an example of how the magnitude of disparity looks like. The information indicating the magnitude of disparity may be expressed in length or the number of pixels. As shown in FIG. 3, when the magnitude of disparity is expressed in length, the amount of disparity is d1 because the discrepancy between left-eye video images 130 and right-eye video images 140 is d1. When the magnitude of disparity is expressed in the number of pixels, the magnitude of disparity is 4 pixels because the discrepancy between the left-eye video images 130 and the right-eye video images 140 is 4 pixels. The disparity magnitude detector 105 holds d1 or 4 pixels as the information indicating the magnitude of disparity.

The projection distance detector 108 has a function of measuring the projection distance. The projection distance is detected by ultrasonic wave-based distance measurement or infrared laser- or red laser-based distance measurement.

The ultrasonic wave-based distance measurement will be described. The projection distance detector 108 radiates ultrasonic waves as the incident signal D1 toward the screen 20. The radiated incident signal D1 is reflected off the screen 20, and the projection distance detector 108 receives the reflected signal as the reflection signal D2. The projection distance detector 108 is designed to measure the period from the time when the incident signal D1 is transmitted to the time when the reflection signal D2 is received (the period during which the ultrasonic wave propagates) and calculate the projection distance from the measured period. The projection distance detector 108 can thus measure the projection distance.

The infrared laser- or red laser-based distance measurement will be described. The projection distance detector 108 radiates an infrared or red laser beam as an incident signal D1′ toward the screen 20. The radiated incident signal D1′ is reflected off the screen 20, and the projection distance detector 108 receives the reflected signal as a reflection signal D2′.

Examples of the infrared laser- or red laser-based distance measurement include a time-of-flight method and a triangulation method. The time-of-flight method, like the ultrasonic wave-based distance measurement, involves measuring the period from the time when the projection distance detector 108 transmits the incident signal D1′ to the time when the projection distance detector 108 receives the reflection signal D2′ (the period during which the light propagates) and calculating the projection distance from the measured period. In the triangulation method, a linear array of light receiving devices is provided in the projection distance detector 108, and the projection distance is calculated by detecting the position where the reflection signal D2′ is received by the light receiving devices.

The measurement of the projection distance may be carried out when the display apparatus 100 is powered on or when the video signal Sin is inputted. The measurement of the projection distance may even be carried out periodically at intervals on the order of several seconds or several minutes. The resolution of the projection distance measurement and the range within which the projection distance is measured are, for example, approximately 1 cm in a range from several tens of centimeters to 10 meters.

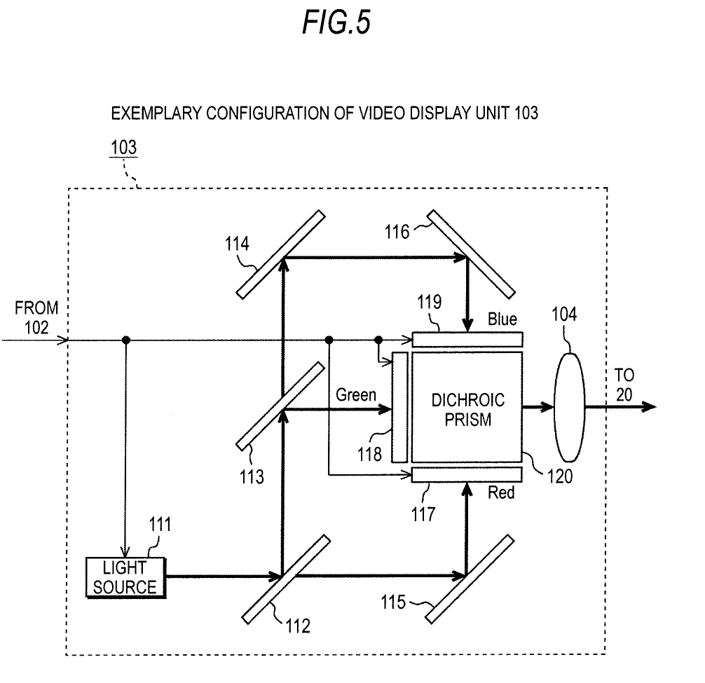

The display size calculator 106 has a function of calculating the size of video images displayed on the screen 20. The graphs in FIG. 4 show examples of the relationship between the projection distance and the display size. As shown in FIG. 4, the horizontal axis represents the projection distance and the vertical axis represents the display size. The straight line connecting the filled black circles in FIG. 4 represents an example of the relationship between the projection distance and the display size when the magnification of the zoom lens is fixed to unity, whereas the broken line connecting the triangles represents an example of the relationship between the projection distance and the display size when the magnification of the zoom lens is fixed to two.

When the magnification of the zoom lens is fixed, the display size is proportional to the projection distance. The display size calculator 106 can convert the detected projection distance into a desired display size based on the proportional relationship between the projection distance and the display size, for example, that shown in FIG. 4.

The video display unit 103 has a function of producing video images based on the video signal Sin outputted from the disparity magnitude adjuster 102 and displaying the video images on the screen 20 through the zoom lens provided in the video display unit 103. The video display unit 103 further has a function of holding information indicating the horizontal and vertical resolution of the video images displayed on the screen 20.

FIG. 5 is a descriptive diagram showing an exemplary configuration of the video display unit 103. As shown in FIG. 5, the video display unit 103 includes a light source 111, dichroic mirrors 112 and 113, reflection mirrors 114, 115, and 116, a liquid crystal panel for red light (hereinafter referred to as a liquid crystal panel 117), a liquid crystal panel for green light (hereinafter referred to as a liquid crystal panel 118), a liquid crystal panel for blue light (hereinafter referred to as a liquid crystal panel 119), a dichroic prism 120, and a zoom lens 104.

The video signal Sin outputted from the disparity magnitude adjuster 102 is sent to the light source 111 and the liquid crystal panels 117, 118, and 119. In response to the video signal Sin, the light source 111 undergoes illumination control; illumination is initiated or terminated, and the light emission intensity is adjusted. The light source 111 is formed of a metal halide lamp, a halogen lamp, a xenon lamp, or any other suitable lamp.

As shown in FIG. 5, the light emitted from the light source 111 partly passes through the dichroic mirror 112 and is partly reflected off the dichroic mirror 112. The light having passed through the dichroic mirror 112 is reflected off the reflection mirror 115 and illuminates the liquid crystal panel 117. The light having been reflected off the dichroic mirror 112 partly passes through the dichroic mirror 113 and is partly reflected off the dichroic mirror 113. The light having been reflected off the dichroic mirror 113 illuminates the liquid crystal panel 118. The light having passed through the dichroic mirror 113 is reflected off the reflection mirror 114. The light having been reflected off the reflection mirror 114 is reflected off the reflection mirror 116 and illuminates the liquid crystal panel 119.

Each of the liquid crystal panels 117, 118, and 119 has a function of converting the received video signal Sin into video images. Each of the liquid crystal panels 117, 118, and 119 forms an image therein based on the video signal Sin. The light emitted from the light source 111 and incident on the liquid crystal panels 117, 118, and 119 with the images formed therein passes through the liquid crystal panels 117, 118, and 119.

As described above, the liquid crystal panels 117, 118, and 119 with the images formed therein transmit the light and output the red, green, and blue images to the dichroic prism 120. The dichroic prism 120 receives the red, green, and blue video images from the liquid crystal panels 117, 118, and 119, combines the video images, and outputs the combined video images to the zoom lens 104. The zoom lens 104 displays the outputted video images on the screen 20.

The disparity magnitude adjuster 102 uses the information indicating the magnitude of disparity detected by the disparity magnitude detector 105 and the display size calculated by the display size calculator 106 to adjust the magnitude of disparity. Now, let dp1 [pixel] be the information indicating the magnitude of disparity detected by the disparity magnitude detector 105, W [mm] be the horizontal length of the video images displayed on the screen 20, the length calculated by the display size calculator 106, H [pixel] be the horizontal resolution of the video images displayed on the screen 20, dl1 [mm] be the magnitude of disparity before adjusted, and dl2 [mm] be the magnitude of disparity after adjusted.

The disparity magnitude adjuster 102 stores the information dp1 indicating the magnitude of disparity detected by the disparity magnitude detector 105, the horizontal length W of the video images that is calculated by the display size calculator 106, and the horizontal resolution H held in the video display unit 103. The disparity magnitude adjuster 102 uses the information dp1 indicating the magnitude of disparity, the horizontal length W of the video images, and the horizontal resolution H along with the following equation (1) to calculate the magnitude of disparity dl1:

$$dl 1 = dp 1 \times \frac{W}{H} \qquad [ Equation 1 ]$$

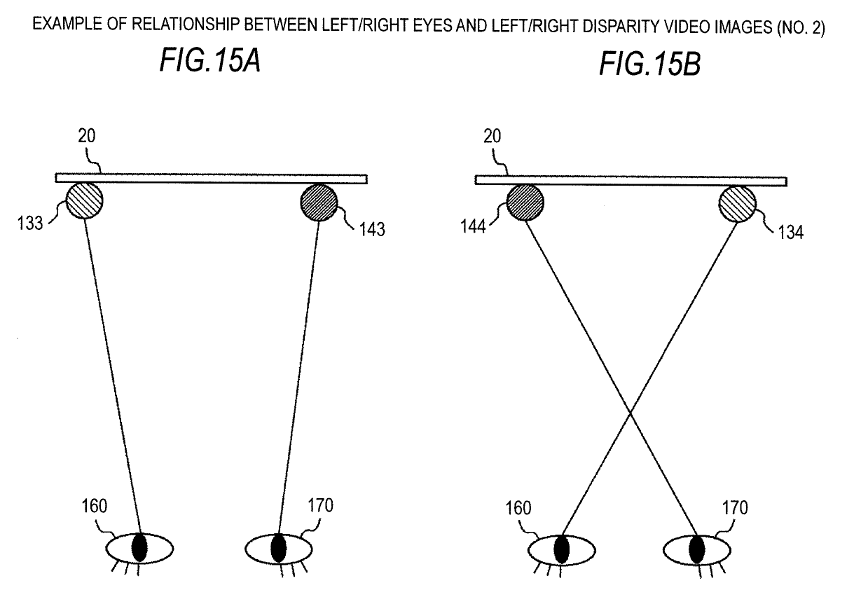

The disparity magnitude adjuster 102 judges based on the calculated dl1 whether or not the magnitude of disparity should be adjusted. When the magnitude of disparity is too large as shown in FIGS. 15A and 15B, the magnitude of disparity is adjusted. For example, since the distance between the left and right eyes of an average person is approximately 65 mm, which is set as a reference value used to judge whether or not the magnitude of disparity is adjusted, the magnitude of disparity is adjusted when dl1 is greater than 65 mm. Alternatively, the viewer may arbitrarily set the reference value used to judge whether or not the magnitude of disparity is adjusted.

The disparity magnitude adjuster 102 sets in advance the magnitude of disparity dl2, which is the magnitude of disparity after adjusted, for example, at 65 mm or smaller. Alternatively, the viewer may arbitrarily set the magnitude of disparity dl2. The disparity magnitude adjuster 102 shifts the left and right disparity video images in the horizontal direction in such a way that the thus set magnitude of disparity dl2 is achieved. When the disparity magnitude adjuster 102 judges that the magnitude of disparity does not need to be adjusted, the disparity magnitude adjuster 102 does not adjust the magnitude of disparity but sets the magnitude of disparity as follows: dl2=dl1.

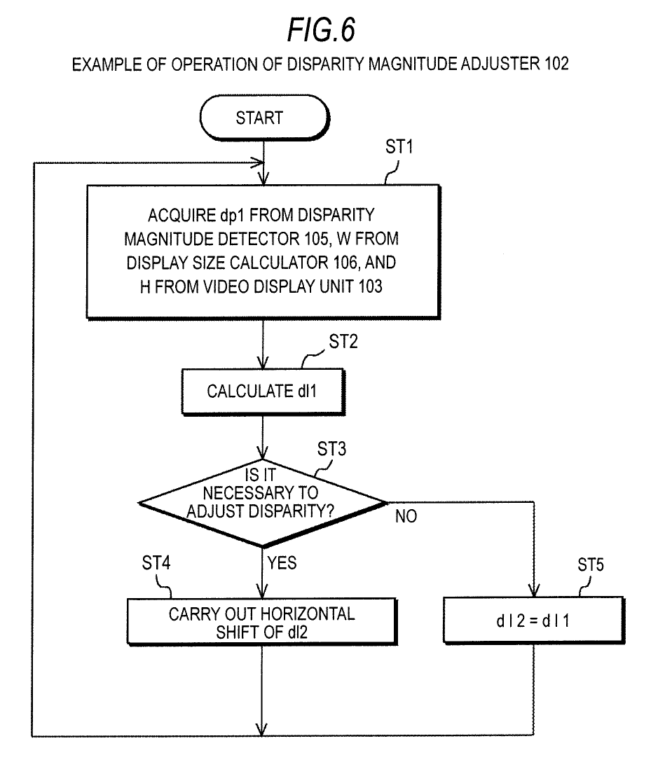

FIG. 6 is a flowchart showing an example of the operation of the disparity magnitude adjuster 102. As shown in FIG. 6, the disparity magnitude adjuster 102 acquires the information dp1 indicating the magnitude of disparity, the horizontal length W of the video images, and the horizontal resolution H of the video images in the step ST1.

The control then proceeds to the step ST2, and the disparity magnitude adjuster 102 uses the acquired information dp1 indicating the magnitude of disparity, horizontal length W of the video images, and horizontal resolution H of the video images along with Equation 1 described above to calculate the magnitude of disparity dl1.

The control proceeds to the step ST3, and the disparity magnitude adjuster 102 judges from the calculated magnitude of disparity dl1 whether or not it is necessary to adjust the magnitude of disparity. For example, the disparity magnitude adjuster 102 judges whether the magnitude of disparity dl1 is greater than 65 mm.

When it is necessary to adjust the magnitude of disparity (when the magnitude of disparity dl1 is greater than 65 mm, for example), the control proceeds to the step ST4, and the disparity magnitude adjuster 102 shifts the left and right disparity video images in the horizontal direction in such a way that the magnitude of disparity becomes dl2. The control then proceeds to the step ST1. For example, the magnitude of disparity dl2 has been set in advance at a value smaller than 65 mm and held in the disparity magnitude adjuster 102.

When it is not necessary to adjust the magnitude of disparity (when the magnitude of disparity dl1 is smaller than or equal to 65 mm, for example), the control proceeds to the step ST5, and the disparity magnitude adjuster 102 does not adjust the magnitude of disparity but sets the magnitude of disparity as follows: dl2=dl1. The control then proceeds to the step ST1.

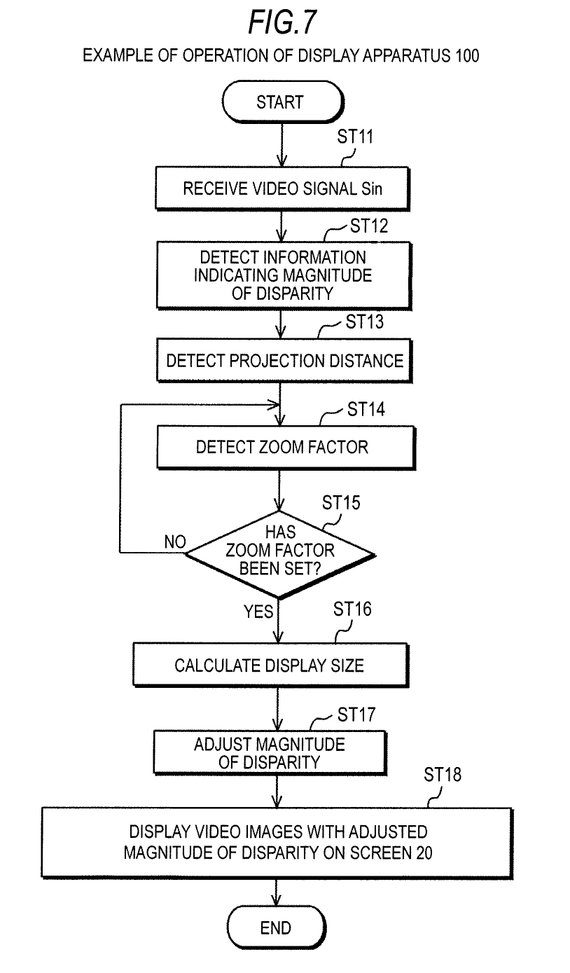

A display method according to an embodiment of the invention will next be described. FIG. 7 is a flowchart showing an example of the operation of the display apparatus 100. As shown in FIG. 7, the video signal input unit 101 receives the video signal Sin containing the information dp1 indicating the magnitude of disparity between the left-eye and right-eye video images in the step ST11.

The control proceeds to the step ST12, and the disparity magnitude detector 105 detects the information dp1 indicating the magnitude of disparity from the received video signal Sin.

The control proceeds to the step ST13, and the projection distance detector 108 uses an ultrasonic wave or a laser beam to detect the projection distance, which is the distance between the display apparatus 100 or the video display unit 103 and the screen 20, on which the video images are displayed.

The control proceeds to the step ST14, and the zoom factor detector 107 detects the zoom factor, which is the magnification of the zoom lens incorporated in the video display unit 103.

The control proceeds to the step ST15, and the zoom factor detector 107 judges whether or not the zoom factor has been set. The zoom factor is set by the user. For example, a zoom factor setting button (not shown) can be provided in the display apparatus 100, and the user can press the button to set the zoom factor arbitrarily. The zoom factor detector 107 senses whether or not the zoom factor setting button has been pressed. When the button has not been pressed, the control proceeds to the step ST14 and the zoom factor detector 107 detects the zoom factor again. When the zoom factor setting button has been pressed, the control proceeds to the step ST16.

In the step ST 16, the display size calculator 106 uses the projection distance detected in the step ST13 and the zoom factor detected in the step ST14 to calculate the size of the video images displayed on the screen 20.

The control proceeds to the step ST17, and the disparity magnitude adjuster 102 converts the information dp1 indicating the magnitude of disparity detected by the disparity magnitude detector 105 into the magnitude of disparity dl1 and uses the magnitude of disparity dl1 and the video image display size calculated by the display size calculator 106 to adjust the magnitude of disparity of the video images displayed on the screen 20.

The control proceeds to the step ST18, and the video display unit 103 displays the left and right disparity video images with the magnitude of disparity adjusted by the disparity magnitude adjuster 102.

As described above, the display apparatus 100 and the display method according to the first embodiment employs the disparity magnitude adjuster 102, which uses the video image display size calculated by the display size calculator 106 and the information indicating the magnitude of disparity detected by the disparity magnitude detector 105 to adjust the magnitude of disparity.

The configuration described above relieves the user of the burden of adjusting the magnitude of disparity but provides an optimized magnitude of disparity, whereby the magnitude of disparity can be automatically adjusted. As a result, the display apparatus 100 can have a function of automatically adjusting the magnitude of disparity irrespective of the environment where the display apparatus 100 is installed.

### Second Embodiment

### When Two Display Apparatus are Used

### No. 1

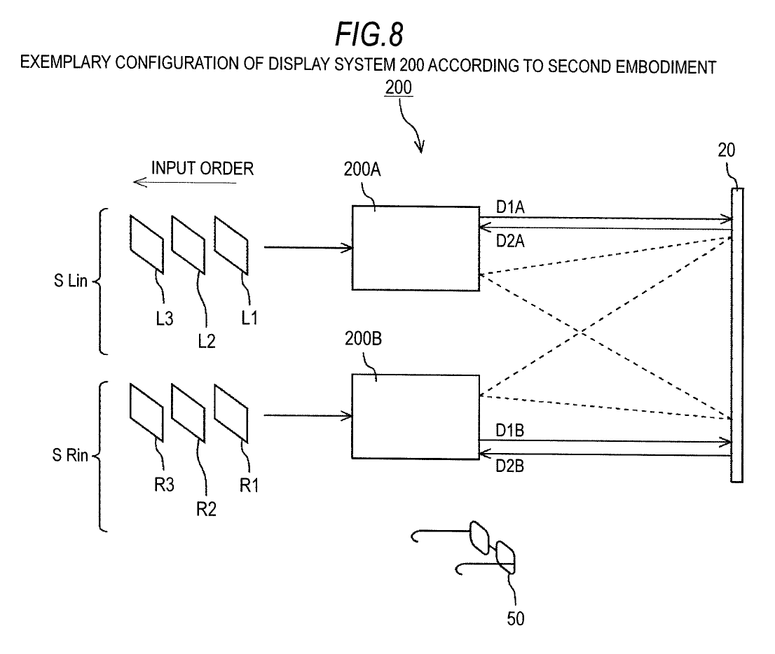

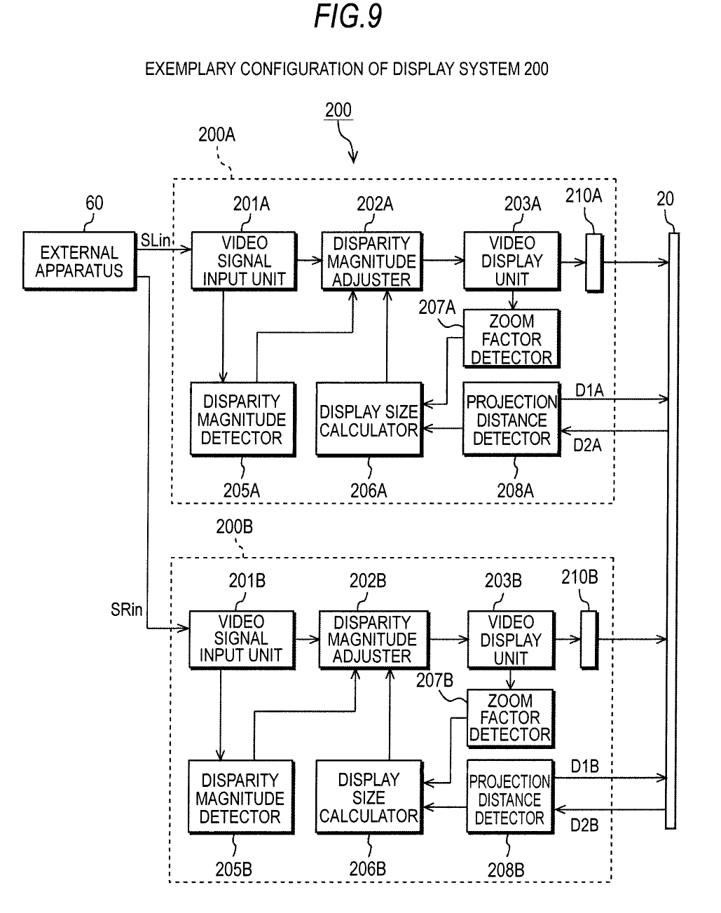

FIG. 8 is a descriptive diagram showing an exemplary configuration of a display system 200 according to a second embodiment, and FIG. 9 is a block diagram of the display system 200. The display system 200 shown in FIGS. 8 and 9 uses two display apparatus 100 according to the first embodiment described above to display left and right disparity video images.

As shown in FIGS. 8 and 9, the display system 200 includes a first display apparatus that displays left-eye video images (hereinafter referred to as a display apparatus 200A) and a second display apparatus that displays right-eye video images (hereinafter referred to as a display apparatus 200B).

The display apparatus 200A includes a first disparity magnitude adjuster (hereinafter referred to as a disparity magnitude adjuster 202A), a first video display unit (hereinafter referred to as a video display unit 203A), a first disparity magnitude detector (hereinafter referred to as a disparity magnitude detector 205A), a first display size calculator (hereinafter referred to as a display size calculator 206A), and a first projection distance detector (hereinafter referred to as a projection distance detector 208A). The display apparatus 200A further includes a first video signal input unit (hereinafter referred to as a video signal input unit 201A), a first polarizing filter (hereinafter referred to as a polarizing filter 210A), and a first zoom factor detector (hereinafter referred to as a zoom factor detector 207A).

The display apparatus 200B includes a second disparity magnitude adjuster (hereinafter referred to as a disparity magnitude adjuster 202B), a second video display unit (hereinafter referred to as a video display unit 203B), a second disparity magnitude detector (hereinafter referred to as a disparity magnitude detector 205B), a second display size calculator (hereinafter referred to as a display size calculator 206B), and a second projection distance detector (hereinafter referred to as a projection distance detector 208B). The display apparatus 200B further includes a second video signal input unit (hereinafter referred to as a video signal input unit 201B), a second polarizing filter (hereinafter referred to as a polarizing filter 210B), and a second zoom factor detector (hereinafter referred to as a zoom factor detector 207B).

Since the disparity magnitude adjusters 202A and 202B, the video display units 203A and 203B, the disparity magnitude detectors 205A and 205B, the display size calculators 206A and 206B, the projection distance detectors 208A and 208B, the video signal input units 201A and 2013, and the zoom factor detectors 207A and 207B have functions that are the same as those of the disparity magnitude adjuster 102, the video display unit 103, the disparity magnitude detector 105, the display size calculator 106, the projection distance detector 108, the video signal input unit 101, and the zoom factor detector 107, no redundant description will be made.

The video signal input unit 201A receives from an external apparatus 60 a video signal SLin formed of left-eye image signals L1, L2, and L3 and information indicating the magnitude of disparity between left and right disparity video images. The video signal input unit 201B receives from the external apparatus 60 a video signal SRin formed of right-eye image signals R1, R2, and R3 and the information indicating the magnitude of disparity between the left and right disparity video images.

While the present embodiment will be described under the assumption that each of the video signals SLin and SRin contains the information indicating the magnitude of disparity between the left and right disparity video images, the magnitude of disparity can be adjusted when one of the video signals SLin and SRin contains the information indicating the magnitude of disparity between the left and right disparity video images.

The projection distance detector 208A detects the distance between the video display unit 203A and a screen 20 (hereinafter referred to as a left-eye projection distance) by radiating an incident signal D1A to the screen 20 and receiving a reflection signal D2A reflected off the screen 20.

The disparity magnitude adjuster 202A uses the detected left-eye projection distance and the information indicating the magnitude of disparity contained in the video signal SLin to adjust the magnitude of disparity. The polarizing filter 210A is provided in a zoom lens (not shown) that forms the video display unit 203A, and the display apparatus 200A displays polarized left-eye video images with adjusted magnitude of disparity on the screen 20.

On the other hand, the projection distance detector 208B detects the distance between the video display unit 203B and the screen 20 (hereinafter referred to as a right-eye projection distance) by radiating an incident signal D1B to the screen 20 and receiving a reflection signal D2B reflected off the screen 20.

The disparity magnitude adjuster 20213 uses the detected right-eye projection distance and the information indicating the magnitude of disparity contained in the video signal SRin to adjust the magnitude of disparity. The polarizing filter 210B is provided in a zoom lens (not shown) that forms the video display unit 203B, and the display apparatus 200B displays right-eye video images with adjusted magnitude of disparity on the screen 20.

The viewer wears polarizing glasses 50 and looks at the video images displayed on the screen 20. The polarizing glasses 50 include a polarizing filer in the left-eye lens of the polarizing glasses 50 so that it receives the left-eye video images polarized by the left-eye polarizing filer 210A. The polarizing glasses 50 further include another polarizing filer in the right-eye lens of the polarizing glasses 50 so that it receives the right-eye video images polarized by the polarizing filer 210B.

The configuration described above allows the viewer who wears the polarizing glasses 50 to receive only the left-eye video images with the left-eye of the viewer and only the right-eye video images with the right-eye of the viewer. The viewer, who wears the polarizing glasses 50 and looks at video images displayed on the screen 20, can view three-dimensional stereoscopic video images.

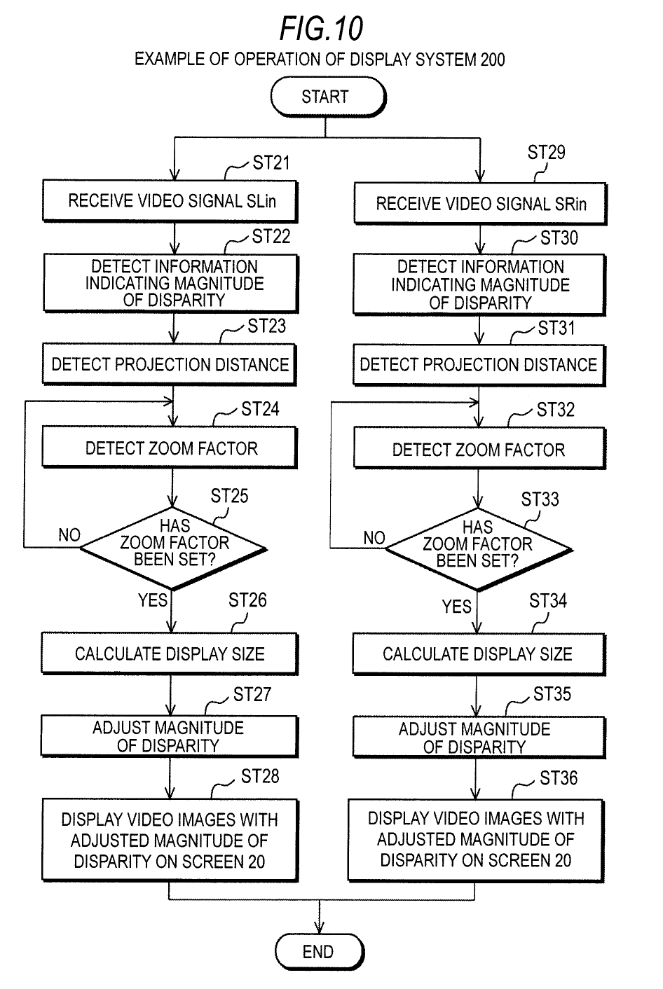

The operation of the display system 200 will next be described. FIG. 10 is a flowchart showing an example of the operation of the display system 200. As shown in FIG. 10, the steps ST21 to ST28 are the operations of the display apparatus 200A, and the steps ST29 to ST36 are the operations of the display apparatus 200B.

In the step ST21, the video signal input unit 201A receives the video signal SLin containing the information indicating the magnitude of disparity between the left-eye and right-eye video images.

The control proceeds to the step ST22, and the disparity magnitude detector 205A detects the information indicating the magnitude of disparity from the received video signal SLin.

The control proceeds to the step ST23, and the projection distance detector 208A uses an ultrasonic wave or a laser beam to detect the projection distance, which is the distance between the video display unit 203A and the screen 20, on which the video images are displayed.

The control proceeds to the step ST24, and the zoom factor detector 207A detects the zoom factor, which is the magnification of the zoom lens incorporated in the video display unit 203A.

The control proceeds to the step ST25, and the zoom factor detector 207A judges whether or not the zoom factor has been set. When the zoom factor has not been set, the control proceeds to the step ST24, and the zoom factor detector 207A detects the zoom factor again. When the zoom factor has been set, the control proceeds to the step ST26.

In the step ST26, the display size calculator 206A uses the projection distance detected in the step ST23 and the zoom factor detected in the step ST24 to calculate the size of the video images displayed on the screen 20.

The control proceeds to the step ST27, and the disparity magnitude adjuster 202A converts the information indicating the magnitude of disparity detected by the disparity magnitude detector 205A into the magnitude of disparity, and uses the converted magnitude of disparity and the video image display size calculated by the display size calculator 206A to adjust the magnitude of disparity of the video images displayed on the screen 20.

The control proceeds to the step ST28, and the video display unit 203A uses the magnitude of disparity adjusted by the disparity magnitude adjuster 202A to display the left-eye video images on the screen 20 through the polarizing filer 210A.

In the step ST29, the video signal input unit 201B receives the video signal SRin containing the information indicating the magnitude of disparity between the left-eye and right-eye video images.

The control proceeds to the step ST30, and the disparity magnitude detector 205B detects the information indicating the magnitude of disparity from the received video signal SRin.

The control proceeds to the step ST31, and the projection distance detector 208B uses an ultrasonic wave or a laser beam to detect the projection distance, which is the distance between the video display unit 203B and the screen 20, on which the video images are displayed.

The control proceeds to the step ST32, and the zoom factor detector 207B detects the zoom factor, which is the magnification of the zoom lens incorporated in the video display unit 203B.

The control proceeds to the step ST33, and the zoom factor detector 207B judges whether or not the zoom factor has been set. When the zoom factor has not been set, the control proceeds to the step ST32, and the zoom factor detector 207B detects the zoom factor again. When the zoom factor has been set, the control proceeds to the step ST34.

In the step ST34, the display size calculator 206B uses the projection distance detected in the step ST31 and the zoom factor detected in the step ST32 to calculate the size of the video images displayed on the screen 20.

The control proceeds to the step ST35, and the disparity magnitude adjuster 202B converts the information indicating the magnitude of disparity detected by the disparity magnitude detector 205B into the magnitude of disparity, and uses the converted magnitude of disparity and the video image display size calculated by the display size calculator 206B to adjust the magnitude of disparity of the video images displayed on the screen 20.

The control proceeds to the step ST36, and the video display unit 203B uses the magnitude of disparity adjusted by the disparity magnitude adjuster 202B to display the right-eye video images on the screen 20 through the polarizing filer 210B.

As described above, the display system 200 according to the second embodiment employs the disparity magnitude adjusters 202A and 202B, which use the video image display sizes calculated by the display size calculators 206A and 206B and the information indicating the magnitudes of disparity detected by the disparity magnitude detectors 205A and 205B to adjust the magnitudes of disparity.

The configuration described above relieves the user of the burden of adjusting the magnitudes of disparity but provides optimized magnitudes of disparity, whereby the magnitudes of disparity can be automatically adjusted. As a result, the display system 200 using the two display apparatus 200A and 200B can have a function of automatically adjusting the magnitudes of disparity irrespective of the environment where the display system 200 is installed.

### Third Embodiment

### When Two Display Apparatus are Used

### No. 2

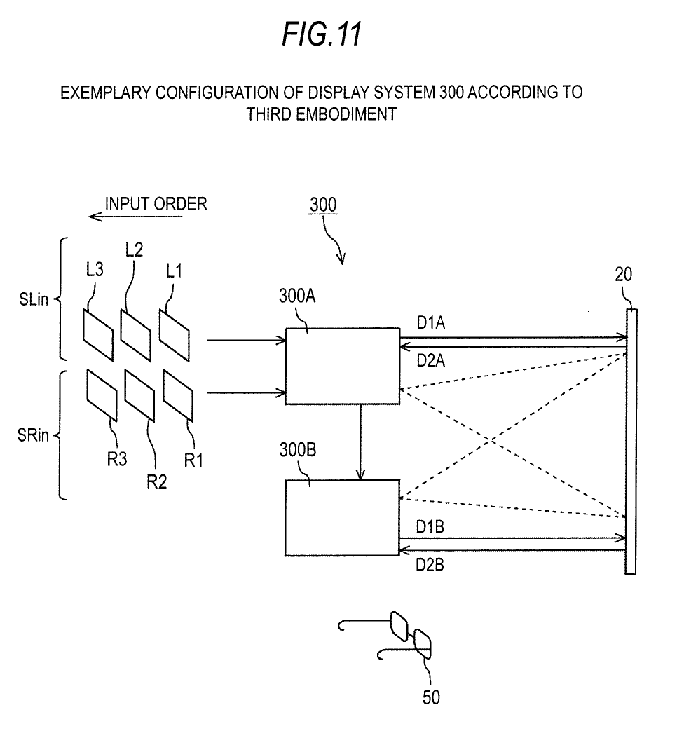

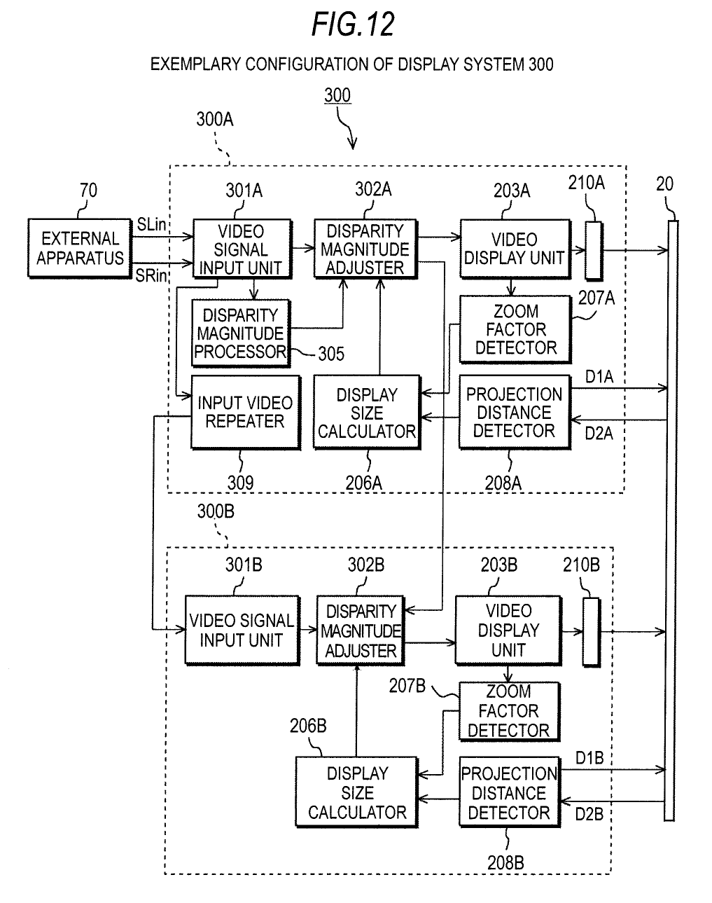

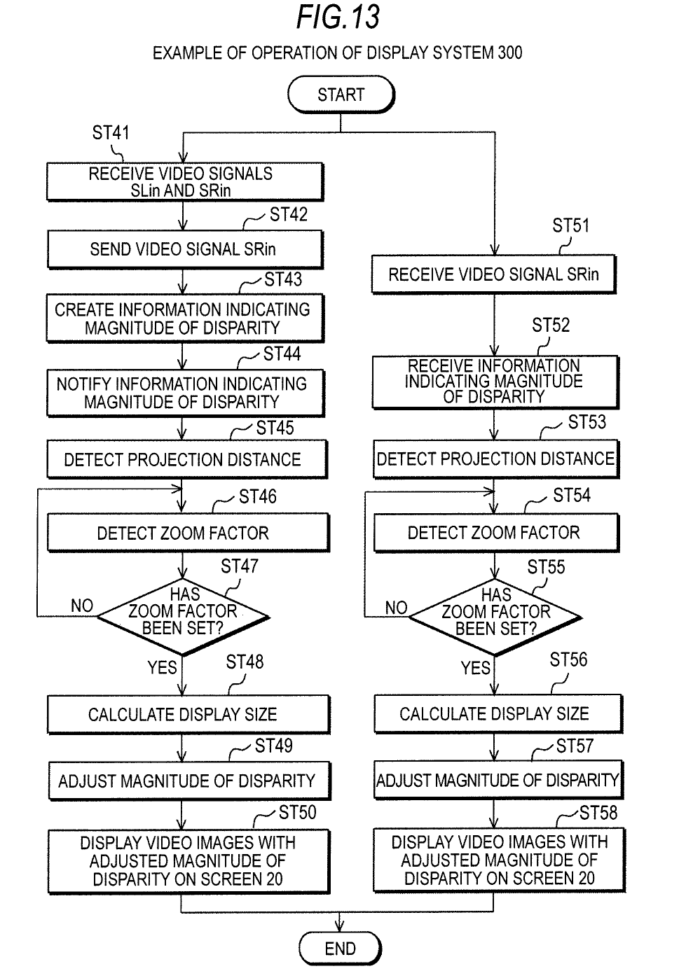

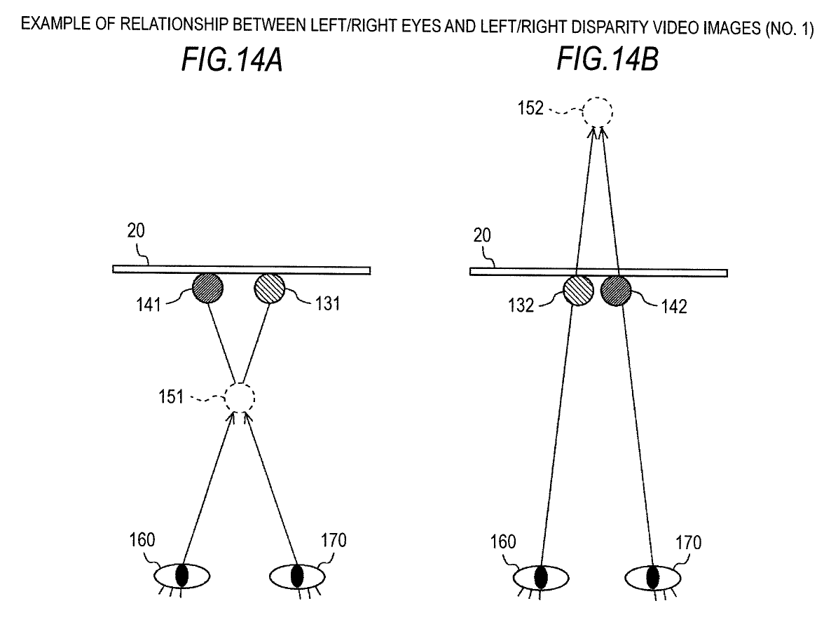

FIG. 11 is a descriptive diagram showing an exemplary configuration of a display system 300 according to a third embodiment, and FIG. 12 is a block diagram of the display system 300. The display system 300 shown in FIGS. 11 and 12 is similar to the display system 200 according to the second embodiment described above but has a function of creating information indicating the magnitude of disparity. Since the portions having the same names and reference characters as those in the second embodiment have the same functions, no redundant description will be made.

As shown in FIGS. 11 and 12, the display system 300 includes a first display apparatus that displays left-eye video images (hereinafter referred to as a display apparatus 300A) and a second display apparatus that displays right-eye video images (hereinafter referred to as a display apparatus 300B).

The display apparatus 300A includes a first disparity magnitude adjuster (hereinafter referred to as a disparity magnitude adjuster 302A), a video display unit 203A, a disparity magnitude processor 305, a display size calculator 206A, a projection distance detector 208A, and an input video repeater 309. The display apparatus 300A further includes a first video signal input unit (hereinafter referred to as a video signal input unit 301A), a polarizing filter 210A, and a zoom factor detector 207A.

The display apparatus 300B includes a second disparity magnitude adjuster (hereinafter referred to as a disparity magnitude adjuster 302B), a video display unit 203B, a display size calculator 2063, and a projection distance detector 208B. The display apparatus 300B further includes a second video signal input unit (hereinafter referred to as a video signal input unit 301B), a polarizing filter 210B, and a zoom factor detector 207B.

The video signal input unit 301A receives from an external apparatus 70 a video signal SLin formed of left-eye image signals L1, L2, and L3 and a video signal SRin formed of right-eye image signals R1, R2, and R3. Since the external apparatus 70 does not have a function of sending information indicating the magnitude of disparity, the video signals SLin and SRin contain no information indicating the magnitude of disparity.

The video signal input unit 301A is connected to the input video repeater 309, and the input video repeater 309 receives the video signal SRin outputted from the video signal input unit 301A. The input video repeater 309 is connected to the video signal input unit 301B, which is part of the display apparatus 3003. The input video repeater 309 sends the video signal SRin to the video signal input unit 3013.

The video signal input unit 301A is also connected to the disparity magnitude processor 305, and the disparity magnitude processor 305 receives the video signals SLin and SRin outputted from the video signal input unit 301A, uses the video signals SLin and SRin to perform stereo matching so that information indicating the magnitude of disparity is created. The disparity magnitude adjuster 302A may alternatively have the function of the disparity magnitude processor 305.

The stereo matching is a process in which each of the left-eye and right-eye images provided from the video signals SLin and SRin is divided into small areas and the distance between the left-eye image and the right-eye image similar to each other for each of the small areas is calculated to determine the correlation between the left-eye image and the right-eye image. The stereo-matching image processing can be performed to create information indicating the magnitude of disparity between left and right disparity video images.

The disparity magnitude processor 305 is connected to the disparity magnitude adjuster 302A. The disparity magnitude adjuster 302A receives the information indicating the magnitude of disparity created by the disparity magnitude processor 305 and adjusts the magnitude of disparity based on the received information indicating the magnitude of disparity and the video image display size calculated by the display size calculator 206A. The disparity magnitude adjuster 302A also notifies the disparity magnitude adjuster 302B of the information indicating the magnitude of disparity created by the disparity magnitude processor 305.

The disparity magnitude adjuster 302B adjusts the magnitude of disparity for the video signal SRin outputted from the video signal input unit 301B described above based on the notified information indicating the magnitude of disparity and the video image display size calculated by the display size calculator 206B.

While in the present embodiment, the input video repeater 309 outputs the video signal SRin to the video signal input unit 301B, the input video repeater 309 can, of course, output the video signal SLin to the video signal input unit 301B. In this case, the display apparatus 300A displays the right-eye video images, whereas the display apparatus 300B displays the left-eye video images.

The operation of the display system 300 will next be described. FIG. 13 is a flowchart showing an example of the operation of the display system 300. As shown in FIG. 13, the steps ST41 to ST50 are the operations of the display apparatus 300A, and the steps ST51 to ST58 are the operations of the display apparatus 300B.

In the step ST41, the video signal input unit 301A receives the video signals SLin and SRin containing left-eye and right-eye video images.

The control proceeds to the step ST42, and the input video repeater 309 sends the received video signal SRin containing the right-eye video images to the video signal input unit 301B.

The control proceeds to the step ST43, and the disparity magnitude processor 305 performs stereo matching based on the received video signals SLin and SRin to create information indicating the magnitude of disparity.

The control proceeds to the step ST44, and the disparity magnitude adjuster 302A notifies the disparity magnitude adjuster 302B of the information indicating the magnitude of disparity created by the disparity magnitude processor 305.

The control proceeds to the step ST45, and the projection distance detector 208A uses an ultrasonic wave or a laser beam to detect the projection distance, which is the distance between the video display unit 203A and the screen 20, on which the video images are displayed.

The control proceeds to the step ST46, and the zoom factor detector 207A detects the zoom factor, which is the magnification of the zoom lens incorporated in the video display unit 203A.

The control proceeds to the step ST47, and the zoom factor detector 207A judges whether or not the zoom factor has been set. When the zoom factor has not been set, the control proceeds to the step ST46, and the zoom factor detector 207A detects the zoom factor again. When the zoom factor has been set, the control proceeds to the step ST48.

In the step ST48, the display size calculator 206A uses the projection distance detected in the step ST45 and the zoom factor detected in the step ST46 to calculate the size of the video images displayed on the screen 20.

The control proceeds to the step ST49, and the disparity magnitude adjuster 302A converts the information indicating the magnitude of disparity created by the disparity magnitude processor 305 into the magnitude of disparity, and uses the converted magnitude of disparity and the video image display size calculated by the display size calculator 206A to adjust the magnitude of disparity of the video images displayed on the screen 20.

The control proceeds to the step ST50, and the video display unit 203A uses the magnitude of disparity adjusted by the disparity magnitude adjuster 302A to display the left-eye video images on the screen 20 through the polarizing filer 210A.

In the step ST51, the video signal input unit 301B receives the video signal SRin containing the right-eye video images and sent via the input video repeater 309 in the step ST42.

The control proceeds to the step ST52, and the disparity magnitude adjuster 302B receives the information indicating the magnitude of disparity notified from the disparity magnitude adjuster 302A in the step ST44.

The control proceeds to the step ST53, and the projection distance detector 208B uses an ultrasonic wave or a laser beam to detect the projection distance, which is the distance between the video display unit 203B and the screen 20, on which the video images are displayed.

The control proceeds to the step ST54, and the zoom factor detector 207B detects the zoom factor, which is the magnification of the zoom lens incorporated in the video display unit 203B.

The control proceeds to the step ST55, and the zoom factor detector 207B judges whether or not the zoom factor has been set. When the zoom factor has not been set, the control proceeds to the step ST54, and the zoom factor detector 207B detects the zoom factor again. When the zoom factor has been set, the control proceeds to the step ST56.

In the step ST56, the display size calculator 206B uses the projection distance detected in the step ST53 and the zoom factor detected in the step ST54 to calculate the size of the video images displayed on the screen 20.

The control proceeds to the step ST57, and the disparity magnitude adjuster 302B converts the information indicating the magnitude of disparity notified from the disparity magnitude adjuster 302A into the magnitude of disparity, and uses the converted magnitude of disparity and the video image display size calculated by the display size calculator 206B to adjust the magnitude of disparity of the video images displayed on the screen 20.

The control proceeds to the step ST58, and the video display unit 203B uses the magnitude of disparity adjusted by the disparity magnitude adjuster 202B to display the right-eye video images on the screen 20 through the polarizing filer 210B.

As described above, in the display system 300 according to the third embodiment, when it receives a video signal containing no information indicating the magnitude of disparity from the external apparatus 70, the disparity magnitude processor 305 performs stereo-matching image processing to create information indicating the magnitude of disparity, and the disparity magnitude adjuster 302A notifies the disparity magnitude adjuster 302B of the created information indicating the magnitude of disparity.

The configuration described above, even when receiving no information indicating the magnitude of disparity from the external apparatus 70, creates information indicating the magnitude of disparity, relieves the user of the burden of adjusting the magnitude of disparity, but provides an optimized magnitude of disparity, whereby the magnitude of disparity can be automatically adjusted. Further, since the display apparatus 300B needs no disparity magnitude detector, the burden on the display apparatus 300B can be reduced.

As a result, the display system 300 using the two display apparatus 300A and 300B can have a function of automatically adjusting the magnitudes of disparity irrespective of the environment where the display system 300 is installed.

The invention is very effective when applied to a front-projection projector that displays three-dimensional stereoscopic video images.

The present application contains subject matter related to that disclosed in Japanese Priority Patent Application JP 2008-266793 filed in the Japan Patent Office on Oct. 15, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a video display unit that converts a video signal containing information indicating the magnitude of disparity between left-eye and right-eye video images into video images and displays the video images on a screen;
a projection distance detector that detects a projection distance that is the distance between the video display unit and the screen;
a display size calculator that calculates the size of the video images displayed on the screen using the projection distance detected by the projection distance detector;
a disparity magnitude detector that detects the information indicating the magnitude of disparity from the video signal; and
a disparity magnitude adjuster that adjusts the magnitude of disparity using the size of the video images displayed on the screen and the information indicating the magnitude of disparity detected by the disparity magnitude detector.

2. The display apparatus according to claim 1,
wherein the video display unit includes a zoom lens that magnifies the video images, the magnification of the zoom lens being a zoom factor,
the video display unit is connected to a zoom factor detector, and
the zoom factor detector detects the zoom factor.

3. The display apparatus according to claim 1 or 2,
wherein the display size calculator calculates the display size of the video images to be displayed using both the projection distance detected by the projection distance detector and the zoom factor detected by the zoom factor detector.

4. The display apparatus according to claim 3,
wherein the projection distance detector detects the projection distance by using an ultrasonic wave.

5. The display apparatus according to claim 3,
wherein the projection distance detector detects the projection distance by using an infrared laser beam or a red laser beam.

6. The display apparatus according to claim 1,
wherein the video display unit is connected to a video signal input unit that receives the video signal,
the disparity magnitude adjuster is connected to a disparity magnitude processor, and
the disparity magnitude processor performs stereo matching to adjust the magnitude of disparity when the video signal input unit does not receive the information indicating the magnitude of disparity.

7. The display apparatus according to claim 6,
wherein the video signal input unit is connected to an input video repeater, and
the input video repeater receives left-eye video information and right-eye video information that have been inputted and sends one of the left-eye video information and the right-eye video information.

8. The display apparatus according to claim 6,
wherein the disparity magnitude adjuster has a function of notifying the information indicating the magnitude of disparity.

9. The display apparatus according to claim 1,
wherein the information indicating the magnitude of disparity is expressed in the number of pixels.

10. A display method that causes a display apparatus displaying left-eye video images and right-eye video images on a screen to carry out the steps of:
receiving a video signal containing information indicating the magnitude of disparity between the left-eye video images and the right-eye video images and detecting the information indicating the magnitude of disparity from the video signal;
detecting a projection distance that is the distance between the display apparatus and the screen;
calculating the size of the video images displayed on the screen using the detected projection distance;
adjusting the magnitude of disparity using the calculated size of the video images to be displayed and the detected information indicating the magnitude of disparity; and
displaying the video images on the screen by using the adjusted magnitude of disparity.

11. A display system comprising:
a first display apparatus including a first video display unit that converts a video signal containing information indicating the magnitude of disparity between left-eye and right-eye video images into video images and displays the video images on a screen, a first projection distance detector that detects a projection distance that is the distance between the first video display unit and the screen, a first display size calculator that calculates the size of the video images displayed on the screen using the projection distance detected by the first projection distance detector, a first disparity magnitude detector that detects the information indicating the magnitude of disparity from the video signal, and a first disparity magnitude adjuster that adjusts the magnitude of disparity using the size of the video images displayed on the screen and the information indicating the magnitude of disparity detected by the first disparity magnitude detector; and
a second display apparatus including a second video display unit that converts the video signal containing the information indicating the magnitude of disparity between the left-eye and right-eye video images into video images and displays the video images on the screen, a second projection distance detector that detects a projection distance that is the distance between the second video display unit and the screen, a second display size calculator that calculates the size of the video images displayed on the screen using the projection distance detected by the second projection distance detector, a second disparity magnitude detector that detects the information indicating the magnitude of disparity from the video signal, and a second disparity magnitude adjuster that adjusts the magnitude of disparity using the size of the video images displayed on the screen and the information indicating the magnitude of disparity detected by the second disparity magnitude detector.

12. The display system according to claim 11,
wherein the first video display unit is connected to a video signal input unit that receives the video signal,
the first disparity magnitude adjuster is connected to a disparity magnitude processor, and
the disparity magnitude processor performs stereo-matching to adjust the magnitude of disparity when the video signal input unit does not receive the information indicating the magnitude of disparity.

13. The display system according to claim 12,
wherein the video signal input unit is connected to an input video repeater, and
the input video repeater receives left-eye video information and right-eye video information that have been inputted and sends one of the left-eye video information and the right-eye video information.
